(19) United States
(12) Patent Application Publication
(10) Pub. No.: US 2005/0129010 A1
(43) Pub. Date: Jun. 16, 2005

(54) Communications terminal

(76) Inventors: Kazuhiro Maeda, Yokohama (JP); Koichi Terui, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 10/823,696

(22) Filed: Apr. 14, 2004

(30) Foreign Application Priority Data
Nov. 21, 2003 (JP) 2003-391619

(51) Int. Cl. H04L 12/28

(52) U.S. Cl. 370/389

(57) ABSTRACT

Conventionally, no provision has been made to perform an update during a period of time during which the user does not use a communications terminal. Frequently used programs and data need be updated frequently, and infrequently used programs and data need not be frequently updated. Therefore, it is preferred that an update be performed depending on the frequency of use. No provision has been made heretofore to perform an update in accordance with frequency of use. To solve these problems, the communications terminal has a communication section for communicating with a server via a communication network, a storage section for storing a program, a control section for controlling the communication section and storage section, and a usage storage section for storing the usage status of the communications terminal, and a program stored in the storage section is updated in accordance with the usage status stored in the usage storage section.

### BACKGROUND OF THE INVENTION

The present invention relates to a communications terminal that is capable of performing a program update and a data update.

For updating a wireless base station program for cellular phones, methods of performing an update during a time slot during which access is infrequently gained by cellular phones has been proposed, for instance, in Japanese Patent Laid-open No. 10-63498.

However, the above-mentioned conventional methods did not attempt to memorize time slots during which the users do not use communications terminals for the purpose of performing an update during such time slots.

Further, the use of a communications terminal varies from one user to another. However, this does not hold true for a wireless base station. Therefore, no provision was made so as to perform an update in accordance with the use, which varies from one user to another.

It is also believed that frequently used programs and data need to be updated frequently, and that infrequently used programs and data need not be frequently updated. It is therefore preferred that an update be performed depending on the frequency of use. However, no provision was made to perform an update in accordance with the frequency of use.

Moreover, it is impossible to update programs and data if the right to update them is not acquired. It is therefore preferred that an update be performed depending on whether the right to update programs and data is acquired. However, no provision was made to perform an update depending on whether the right to update is acquired.

Furthermore, if the communications terminal does not have an adequate capacity for storing an update program or update data, no update can be performed. In such a situation, it is preferred that the capacity be determined. However, no provision was made to determine the capacity available for update program/update data storage.

It is an object of the present invention to solve the aforementioned problems and to provide a user-friendly communications terminal.

### SUMMARY OF THE INVENTION

To achieve the above-stated object, the present invention includes a communication section for establishing communication, a storage section for storing programs, a control section for controlling the communication section and storage section, and a usage storage section for storing information concerning the usage. Further, the present invention uses the usage information stored in the usage storage section to update the programs stored in the storage section.

### BRIEF DESCRIPTION OF THE DRAWINGS

FIG. 1 is a block diagram which illustrates the configuration of a communications terminal and the configuration of an update server.

FIG. 2 is a program update sequence diagram 1.

FIG. 3 is a program update sequence diagram 2.

FIG. 4 is a diagram which illustrates how the contents of a user data storage section and program storage section change.

FIG. 5 is a program update sequence diagram 3.

FIG. 6 is a diagram which illustrates how the contents of a program storage section change.

FIG. 7 is a sequence diagram illustrating the execution of an erased program.

FIG. 8 is a data update sequence diagram 1.

FIG. 9 is a data update sequence diagram 2.

FIG. 10 is a data update sequence diagram 3.

### DETAILED DESCRIPTION OF THE PREFERRED EMBODIMENTS

Preferred embodiments of the present invention will be described with reference to the accompanying drawings.

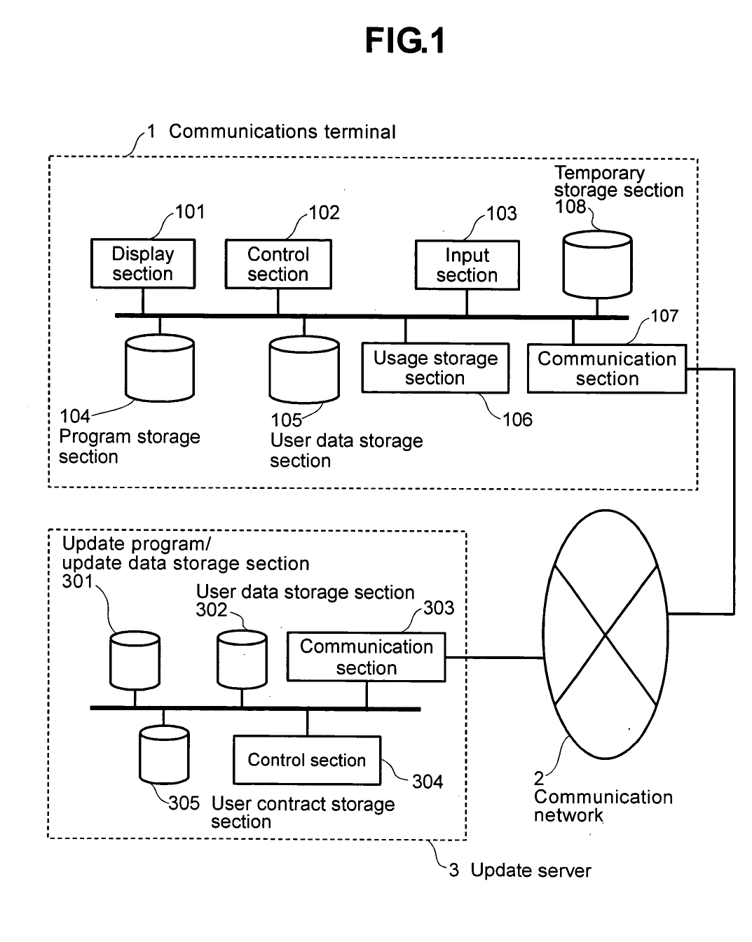

FIG. 1 illustrates the configuration of a communications terminal 1, which is capable of performing a program update and data update, and the configuration of an update server 3, which is used for a program update and data update. The communications terminal 1 is connected to the update server 3 via a communication network 2.

The configuration of the communications terminal 1 will now be described. As shown in FIG. 1, the communications terminal 1 includes a display section 101, a control section 102, an input section 103, a program storage section 104, a user data storage section 105, a usage storage section 106, a communication section 107, and a temporary storage section 108.

The display section 101 is provided as an LCD or other similar device that displays text information, image information, and the like. The display section 101 may be provided with a plurality of screens, such as a main screen and subscreen. The control section 102 controls the overall operation of the communications terminal 1. More specifically, the control section 102 controls the operations of the display section 101, input section 103, program storage section 104, user data storage section 105, usage storage section 106, communication section 107, and temporary storage section 108. The input section 103 allows the user to enter commands or the like into the communications terminal 1 and includes numeric keys, function keys, and a power key.

The program storage section 104 stores various programs that can be executed by the communications terminal 1. For example, the program storage section 104 stores a mail browsing program, a Web browsing program, a still picture recording/playback program, a motion picture recording/playback program, an image editing program, a music/voice recording/playback program, an infrared communication program, a bar code reading program, an OCR program, and a text display program. The program storage section 104 stores not only preset programs, but also programs downloaded by the user.

The user data storage section 105 stores various user data. For example, the user data storage section 105 stores mail data, Web data, still picture data, motion picture data, music data, and voice data. These pieces of data include still picture data and motion picture data picked up by a camera built in the communications terminal, voice data recorded by a built-in voice recorder, music data to be played back by a music player, and data downloaded by the user.

The usage storage section 106 stores, for instance, the date/time, day-of-the-week, and time slot information about the user's use of the communications terminal 1, the frequency and time of the use of various programs, and the frequency and time of the use of various data. More specifically, the information stored by the usage storage section 106 includes a time slot during which the communications terminal 1 is placed on a battery charger, a time slot for automatic program startup, a time slot during which a mail browsing program, Web browsing program, or the like is used by the user, a time slot during which mail messages and Web sites are browsed by the user, and a time slot during which a still picture, motion picture, music, or voice data is played back. The usage storage section 106 also stores the frequency of the user's use of various programs (e.g., the number of times a day, the number of times a week, the number of times a month, and the number of times a year) and the frequency of the user's use of various data (e.g., the number of times a day, the number of times a week, the number of times a month, and the number of times a year). The control section 102 stores these pieces of data into the usage storage section 106 whenever the user uses the communications terminal 1, a program, or data.

The communication section 107 communicates with the update server 3 via the communication network 2 to transmit/receive programs and data. The temporary storage section 108 temporarily stores programs and data. For example, it temporarily stores the currently received update program and update data before they are stored, respectively, into the program storage section 104 and user data storage section 105.

The configuration of the update server 3 will now be described. The update server 3 includes an update program/update data storage section 301, a user data storage section 302, a communication section 303, a control section 304, and a user contract storage section 305.

The update program/update data storage section 301 stores the programs to be used by the communications terminal 1, including a newly created program and update program. The update program/update data storage section 301 also stores the data to be used by the communications terminal 1, including newly created data and update data. In addition to these programs and data, the update program/update data storage section 301 stores previously created programs and data. The update program may be a program containing only differences for modifying a created program, or it may be an updated program itself. The update data may be data containing difference data only, or it may be updated data itself. It is conceivable that a modification program may be used as the update program. Further, storage/distribution data, which includes image data, music data, and text data, may be conceivable as the update data.

The user data storage section 302 stores user data of the communications terminal 1 when the user data is transmitted from the communications terminal 1. The communication section 303 communicates with the communications terminal 1 via the communication network 2. The control section 304 controls the overall operation of the update server 3. More specifically, the control section 304 controls the operations of the update program/update data storage section 301, user data storage section 302, communication section 303, and user contract storage section 305.

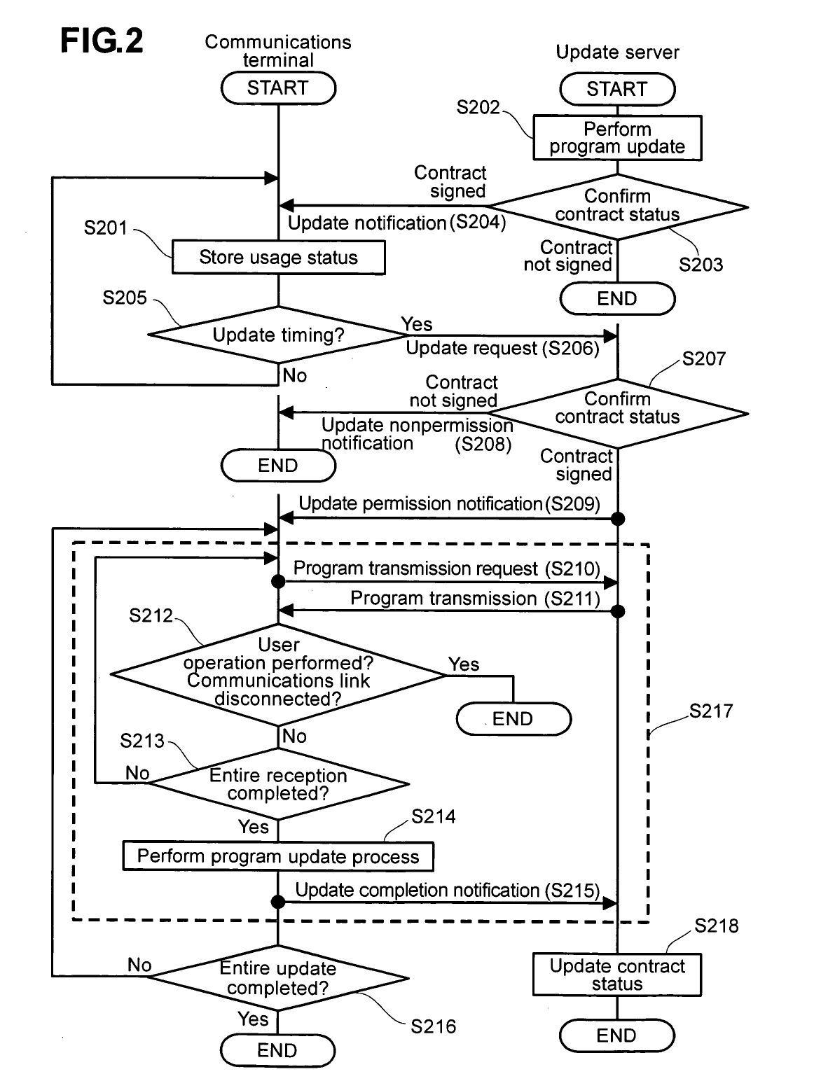

The user contract storage section 305 stores the contract of each user. For example, the user contract storage section 305 stores information that indicates which users are privileged to update what programs and data. More specifically, the user contract storage section 305 stores the relationship between users and programs/data that the users are privileged to update. When a user attempts to update a program or data, the control section 304 references the user contract storage section 305 to determine whether the user is privileged to update the program or data. The process for receiving a program via a communications link and updating the communications terminal's program will now be described with reference to FIG. 2.

FIG. 2 illustrates the program update steps that are followed by the communications terminal 1. More specifically, the steps indicated in this figure relate, for instance, to the procedure that the communications terminal 1 performs to store usage information and update a program with appropriate timing.

(1) The communications terminal 1 causes the control section 102 to store, for instance, the date/time, day-of-the-week, and time slot information about the user's use of the communications terminal 1, the frequency and time of the use of various programs, and the frequency and time of the use of various data into the usage storage section 106 (step S201). As mentioned earlier, the control section 102 stores, for instance, a time slot during which the communications terminal 1 is placed on a battery charger or a time slot during which no automatic program startup is set for the purpose of storing a time slot during which the communications terminal 1, various programs, and curious data are not used. The control section 102 stores these items of information into the usage storage section 106 each time the user uses the communications terminal 1, uses a program, or uses data. The usage information stored in this manner is used, for instance, to perform timing setup for a program update, as will be described later.

(2) When a new program or update program is created, the update server 3 stores it in the update program storage section 301 (step S202).

(3) The update server 3 references the user contract storage section 305 to determine whether the user's contract allows the user to use the newly created program or update program. More specifically, the control section 304 references the user contract storage section 305 to determine whether the user is privileged to perform an update. If the user's contract does not allow the user to use the program (step S203=Contract not signed), the process terminates. If, on the other hand, the user's contract allows the user to use the program (step S203=Contract signed), the process proceeds to step S204.

(4) If it is found that the user's contract allows the user to use the program, the communication section 303 transmits an update notification to the user's communications terminal 1 (step S204). This update notification informs the user's communications terminal 1 that the newly created program or update program exists. The update notification reveals that an updatable program exists in the communications terminal 1.

(5) Upon receipt of the update notification, the control section 102 of the communications terminal 1 references the usage storage section 106 to confirm the update timing and determine the time at which a program update can be performed (step S205). If it is concluded that the program update cannot be performed, or if the update notification is not received in step 5204 (step S205=No), the control section 102 continuously performs step S201 to record the information about usage status.

When, on the other hand, it is concluded that the program update can be performed (step S205=Yes), the control section 102 issues an update request to the update server 3 (step S206).

If, for instance, the usage storage section 106 stores the data about the user's usage, and it is concluded that the communications terminal 1 is not used at around 3:00 a.m. with no user operations being performed, such a time slot is recognized as a program update time slot and is defined as the program update timing. This ensures that no program update is performed during a time slot during which the user uses the communications terminal 1. Consequently, the user is not prevented from using the communications terminal 1. This results in increased user-friendliness.

If a program is set to automatically start up at 6:00 p.m., the program will be updated at a time other than 6:00 p.m. This ensures that the program automatically starts up no matter whether its update is scheduled.

It is also possible to designate frequently used programs as update targets while excluding infrequently used programs that need not be frequently updated. For example, the use frequency (e.g., the number of times a month) of each program stored in the usage storage section 106 can be referenced to refrain from updating programs whose average use frequency per month is lower than 1. In this instance, a threshold value may be set from the outside to determine whether or not to perform an update. Alternatively, the user may perform such an update setup. If it is concluded that no program update need be performed, step S201 is continuously performed to record the information about usage status, as is the case with step S205=No. Programs that need not be updated and programs that do not need frequent updates will then remain unupdated. As a result, the communication cost and traffic can be reduced.

If an urgent program is to be updated (if, for instance, a security-related modification program is to be updated), an update request can be issued (step S206) to give priority to a program update by answering “No” to query step S205. This ensures that an urgent program can be updated immediately to enhance the communications terminal's reliability.

Further, if the user uses the communications terminal during a time slot during which an update can be usually performed, query step S205 may be answered “No” to give priority to the user's use of the communications terminal and continuously perform step S201 to record the usage status. For example, if a time slot during which an update can be performed arrives while the user is making a phone call or browsing a mail message or Web site, priority is given to user operations so that no update is performed. In such an instance, it is preferred that an update request be issued (step S206) by answering “Yes” to query step S205 after termination of the user's use of the communications terminal. This ensures that the user's use of the communications terminal remains uninterrupted. Thus, increased user-friendliness results.

Furthermore, the update timing can be changed in accordance with the current location as far as positional information acquired by a GPS or like device is stored into the usage storage section 106. This makes it possible to perform an update when a predetermined time slot arrives in a situation where the user is found to be at home and is not likely to use the communications terminal, and to refrain from performing an update while the user is away from home and likely to use the communications terminal.

(6) Upon receipt of the update request, the control section 304 of the update server 3 references the user contract storage section 305 to confirm the contract for the communications terminal 1 (step S207). More specifically, the control section 304 checks whether an individual user contract permits the use of the newly created program and update program. If the user's contract does not permit the use of the programs (step S207=Contract not signed), the control section 304 transmits an update nonpermission notification to the communications terminal 1 and the process ends (step S208). If, on the other hand, one or more signed contracts permit the use of the programs (step S207=Contract signed), the control section 304 transmits an update permission notification for only the contracted programs to the communications terminal 1 (step S209).

(7) Upon receipt of the update permission notification, the communications terminal 1 transmits a program transmission request for a program designated by the update permission notification to the update server 3 (step S210). If a plurality of programs are designated by the update permission notification, the communications terminal 1 transmits a program transmission request for one of such programs. Program transmission requests for a plurality of programs will not be simultaneously transmitted. Steps S210 through S215 are performed for each program to transmit a program transmission request for each program.

(8) Upon receipt of the program transmission request, the update server 3 begins to transmit an update program designated by the program transmission request (step S211). The communications terminal 1 begins to receive the update program, which is transmitted from the update server 3, and stores the received update program in the temporary storage section 108. The communications terminal 1 does not directly store the received update program into the program storage section 104 in case the communications link should become disconnected during reception to abort the update program reception process. If the received update program is directly stored into the program storage section 104, it might overwrite the unupdated program. Therefore, if the reception process aborts, the program may become unavailable. The temporary storage section 108 can be effectively used to avoid this problem.

(9) When the program reception process starts, the communications terminal 1 monitors the communication status to check whether the communications link is disconnected (step S212). If the communications link is disconnected due, for instance, to a user operation performed during program reception or a communication link failure (step S212=Yes), the process aborts. If, on the other hand, the communications link is not disconnected (step S212=No), the program reception process continues and proceeds to step S213.

As described above, the communication status is monitored to prevent the program from becoming unavailable due to an interrupted reception operation. A problem arises particularly when a cellular phone or other mobile terminal is used, because such a terminal may move out of the coverage area. The program occurs if, for instance, the mobile terminal moves down into an underground shopping area that is out of the coverage area or is located within a train, bus, taxi, or other vehicle and carried into a tunnel. When the communication status is monitored in a manner described above, it is possible to determine whether the communications link is connected. Even if the communications link is disconnected during reception, it is possible to reconnect the communications link and perform the process again.

If there is an incoming phone call while the update data is being received, the reception process may be aborted by giving priority to the incoming phone call. After the phone call terminates, the communications link can be connected again to perform the process again. This ensures that any incoming phone call can be promptly answered. The user may be allowed to perform setup in advance for giving priority to either the reception process or an incoming phone call or to choose between the reception process and incoming phone call from the display section 101, which prompts the user to make a choice when there is an incoming phone call. If priority is given to the reception process, the reception process continues without informing the user of an incoming phone call. If, on the other hand, priority is given to an incoming phone call, the reception process aborts to inform the user of an incoming phone call. This ensures that the user can perform the reception process to the satisfaction of the user, thereby providing increased user-friendliness.

(10) If the program reception process continues without allowing the communications link to be disconnected, the communications terminal 1 checks whether the program has been entirely received (step S213). If the program has not been entirely received (step S213=No), the program reception process continues. If, on the other hand, if the program has been entirely received (step S213=Yes), the communications terminal 1 concludes that the program has been completely received, and then proceeds to step S214.

(11) When it is concluded that the program has been completely received, the communications terminal 1 performs a program update process from the temporary storage section 108 to the program storage section 104 (step S214). More specifically, the update program stored in the temporary storage section 108 updates (rewrites) the program that is stored in the program storage section 104 and is to be updated. When this process is completed, the program is updated.

This update process may alternatively be performed by applying a patch, which comprises a difference program for modification, to the program to be updated, or by allowing a new program to overwrite the old one.

(12) When the program update process is completed, the communications terminal 1 transmits an update completion notification concerning the updated program to the update server 3 (step S215).

(13) After the update completion notification is transmitted, the communications terminal 1 checks whether all the programs targeted for an update are updated (step S216). If, in step S209, the update permission notification is received for a plurality of programs, processing steps S210 through S215 are performed for each program. Therefore, the communications terminal 1 checks for programs that are left unupdated. If all the programs designated by the update permission notification are not updated (step S216=No), the program update processing sequence, which involves steps S210 through S215, is repeated (step S217). The process terminates when all the programs designated by the update permission notification are completely updated (step S216=Yes).

As described above, an update is performed while considering the user's use of the communications terminal 1. It is therefore possible to perform an update during a time slot during which the user does not use the communications terminal 1, and to provide increased user-friendliness by avoiding a situation where the user cannot use the communications terminal. Further, the frequency of the user's program use can be considered to avoid updating programs that need not be updated. This makes it possible to reduce the cost of communication and the amount of communication data. Since the amount of communication data can be reduced, it is possible to shorten the period of time during which another communications terminal or server cannot access the local communications terminal 1 and reduce the communication traffic. It is also possible to rewrite only the programs targeted for an update in accordance with the contents of the contract, thereby reducing the cost of communication, the amount of communication data, and the volume of communication traffic. Further, the update program is stored in the temporary storage section so that a program update can be performed after the update program is completely received. Therefore, even if the communications link is disconnected during update program reception to abort the update program reception process, the program targeted for an update remains available.

The user can also select programs to be updated. In this instance, the associated setup information is stored in a certain storage section possessed by the communications terminal 1. This makes it possible to update only the programs of the user's choice, thereby reducing the cost of communication and the volume of communication traffic. Further, the user can set the update date/time, day of the week, and time slot and register such setup information. In this instance, the setup information is registered in a certain storage section possessed by the communications terminal 1. This enables the user to set the update timing as desired, providing enhanced user-friendliness.

As regards an update request (step S206), the process for referencing the usage storage section 106 to generate update timing information has been described. Alternatively, however, the user may perform a procedure for generating an update request (step S206). Although a contract for program use has been described, the contract may include a limited number of program updates or the addition of a new program.

Further, the foregoing description deals with a case where the reception process is performed for each program. Alternatively, however, a plurality of programs may be simultaneously received. More specifically, the communications terminal 1 may transmit a program transmission request for a plurality of programs, if the remaining capacity is adequate for receiving the plurality of programs, and cause the update server 3 to simultaneously transmit the plurality of programs.

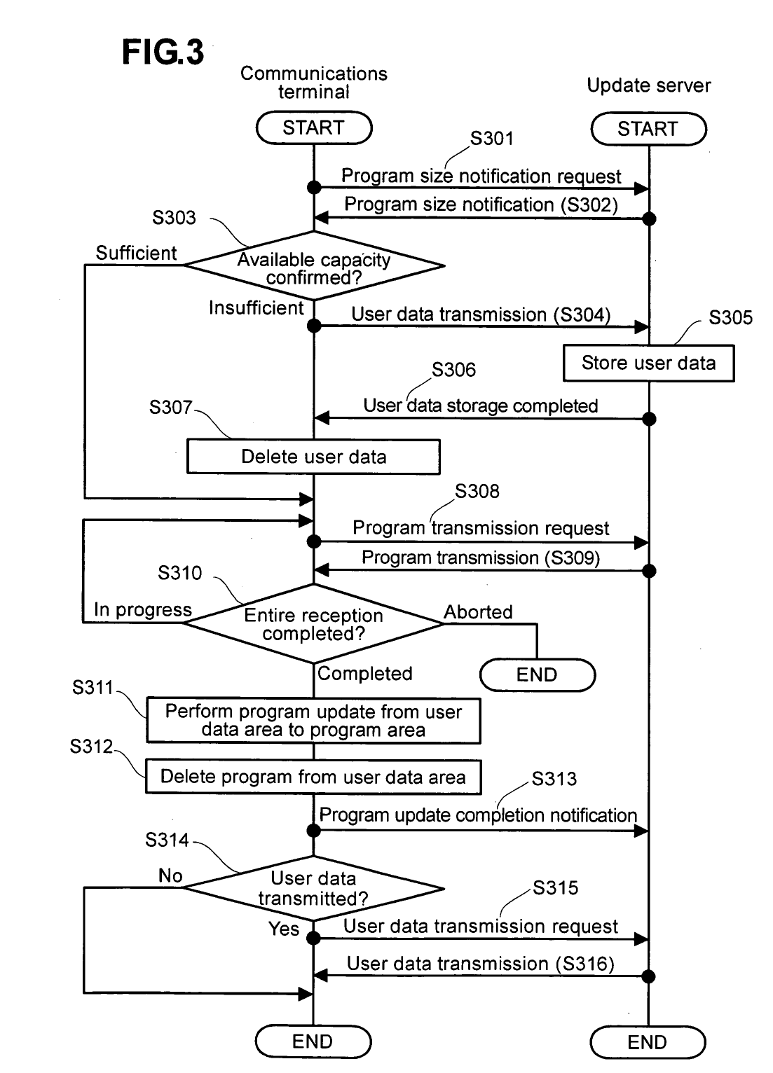

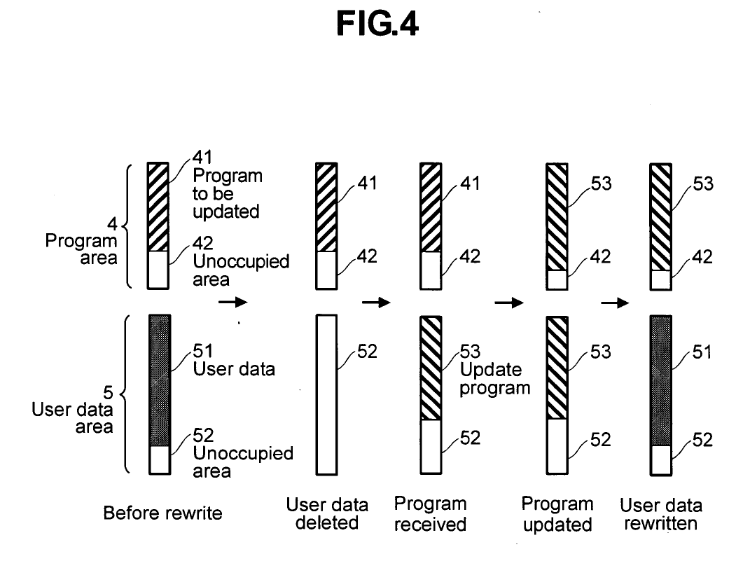

The process for receiving an update program in a situation where the communications terminal 1 does not have an adequate storage capacity will now be described with reference to FIGS. 3 and 4. FIG. 3 illustrates a program update procedure for the communications terminal 1. It is obtained by modifying the program update processing sequence (step S217) shown in FIG. 2. FIG. 4 illustrates how the contents of the program storage section 104 and user data storage section 105 change when the sequence indicated in FIG. 3 is followed.

As shown in FIG. 3, the data in the user data storage section 105 within the communications terminal 1 is transmitted to the update server 3 to delete the data from the user data storage section 105. The resulting free space is then used to receive the update program.

FIG. 4 shows a program area 4; a program 41 targeted for an update; an unoccupied area 42 within the program area; a user data area 5; user data 51; an unoccupied area 52 within the user data area; and an update program 53. It is assumed that the size of the update program is larger than the size of unoccupied area 42 and the size of unoccupied area 52. In this instance, the user data 51 is saved in the server and then deleted so as to receive the update program. If this process is performed, the user data storage section 105 can be used as a temporary storage when the temporary storage section 108 is not incorporated. Further, a program update can be performed even when the user data storage section 105 does not have an adequate free space.

(1) First of all, the communications terminal 1 transmits a program size notification request to the update server 3 (step S301). The program size notification request requests information as to the update program size. It is used to check whether the communications terminal 1 has an adequate free space for receiving the update program.

(2) Upon receipt of the program size notification request, the update server 3 transmits the update program size to the communications terminal 1 (step S302). The program size notification informs the communications terminal 1 of the update program size.

(3) Upon receipt of the program size notification, the communications terminal 1 checks the size of a free space in the user data storage section 105 (step S303). More specifically, the communications terminal 1 checks whether the size of the unoccupied area 52 is larger than the size of the update program. If a sufficient free space is available (step S303=Sufficient), the communications terminal 1 proceeds to step S308 and begins to receive the program. If, on the other hand, the available free space is insufficient (step S303=Insufficient), the communications terminal 1 proceeds to step S304.

(4) When it is concluded that the available free space is insufficient, the communications terminal 1 transmits the user data stored in the user data storage section 105 to the update server (step S304).

(5) When the user data is transmitted from the communications terminal 1, the update server 3 saves the transmitted user data in the user data storage section 302 (step S305). In this instance, the data is saved in such a manner that the user of the transmitted data can be identified. For example, a folder is created for each user and is used to store the associated user data.

(6) After the user data is saved, the update server 3 transmits a user data storage completion notification to the communications terminal 1 (step S306).

(7) Upon receipt of the user data storage completion notification, the communications terminal 1 deletes the user data from the user data storage section 105 (step S307). When this process is completed, the size of the unoccupied area 52 in the user data storage section 105 is rendered larger than the update program size, which is indicated by the program size notification transmitted in step S302, in order to store the update program 53.

(8) When the update program 53 can be stored due to user data deletion, the communications terminal 1 transmits a program transmission request to the update server 3 (step S308).

(9) Upon receipt of the program transmission request, the update server 3 begins to transmit a program that is designated by the program transmission request (step S309). The communications terminal 1 begins to receive the update program, which is transmitted from the update server 3, and then stores the received update program in the user data storage section 105.

(10) While the update program is being received, the communications terminal 1 checks whether the entire program reception process is completed (step S310). If the entire program reception process is not completed (step S310=In progress), the program reception process continues. If the communications link is disconnected during program reception (step S310=Aborted), the process terminates. If, on the other hand, the entire program reception process is completed (step 5310=Completed), the communications terminal 1 concludes that the program reception process is ended, and then proceeds to step S311.

(11) When it is concluded that the entire program reception process is completed, the communications terminal 1 uses the update program 53 stored in the user data storage section 105 to update the program 41 that is stored in the program storage section 104 and targeted for an update (step S311). More specifically, the program stored in the program storage section 104 is updated (rewritten) to create a new program. When this process is performed, the program update is completed.

(12) When the program update is completed, the communications terminal 1 erases the update program 53 from the user data storage section 105 (step S312), and transmits a program update completion notification to the update server 3 (step S313).

(13) After the program update completion notification is transmitted, the communications terminal 1 checks whether the user data is transmitted to the update server 3 (step S314). If the user data is not deleted from the user data storage section 105 (steps S314=No), the process terminates. If, on the other hand, the user data is transmitted to the update server 3 and is deleted from the user data storage section 105 (step S314=Yes), the communications terminal 1 transmits a user data transmission request to the update server 3 (step S315).

(14) Upon receipt of the user data transmission request, the update server 3 transmits the user data stored in the user data storage section 302 to the communications terminal 1 (step S316). The communications terminal 1 stores the received user data in the user data storage section 105 and then terminates the process.

As described above, even when the storage capacity of the communications terminal is limited, the data stored in the user data storage section can be saved into the update server 3 to use the user data storage section 105 as a temporary storage. Therefore, the program targeted for an update can be updated without adding a new work area.

The description given with reference to FIG. 3 has not covered a case where the program reception process (steps S308 and S309) is aborted due, for instance, to a user intervention or communications link failure (step S310=Aborted) so that the process ends with the user data being erased from the communications terminal 1. However, the user data can be acquired by transmitting an acquisition request again to the update server 3. Further, the foregoing description has dealt with a case where the update server 3 unlimitedly saves the user data. However, the update server 3 may alternatively save the user data only when the signed contract states that the storage of user data or an increase or decrease in the storage capacity is in accordance with the contract. If there is no contract for user data storage, the update server 3 may alternatively terminate the program update process because it cannot receive the update program. Although the description given with reference to FIG. 3 has dealt with a case where the user data is transmitted, part of a program or data other than the user data may alternatively be transmitted.

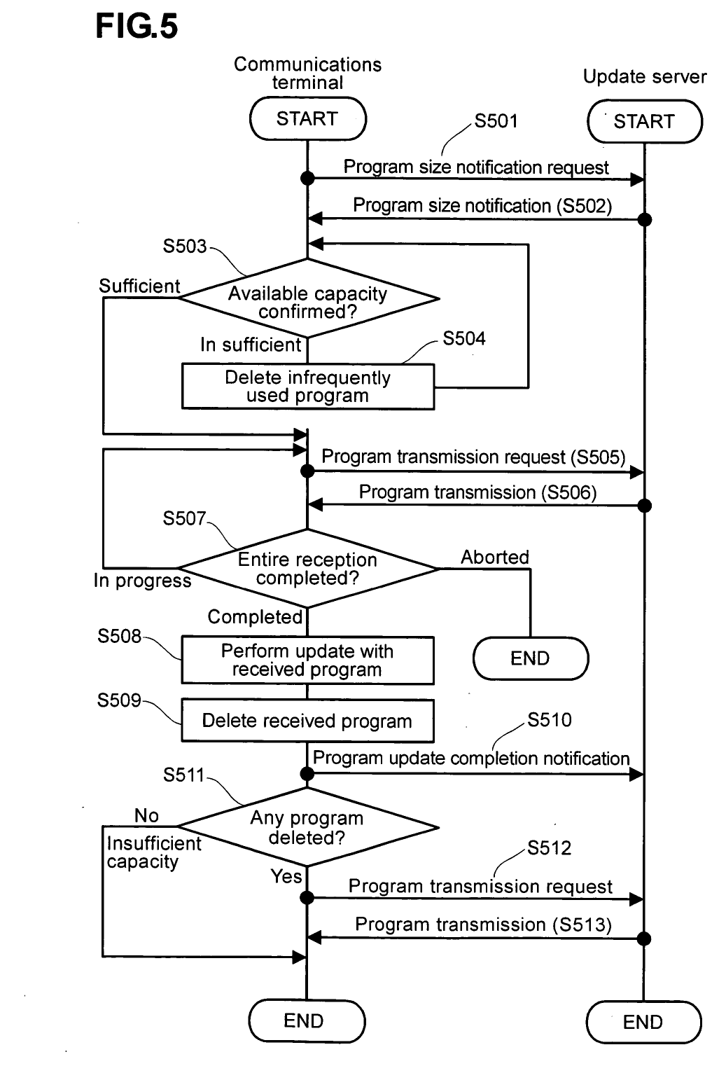

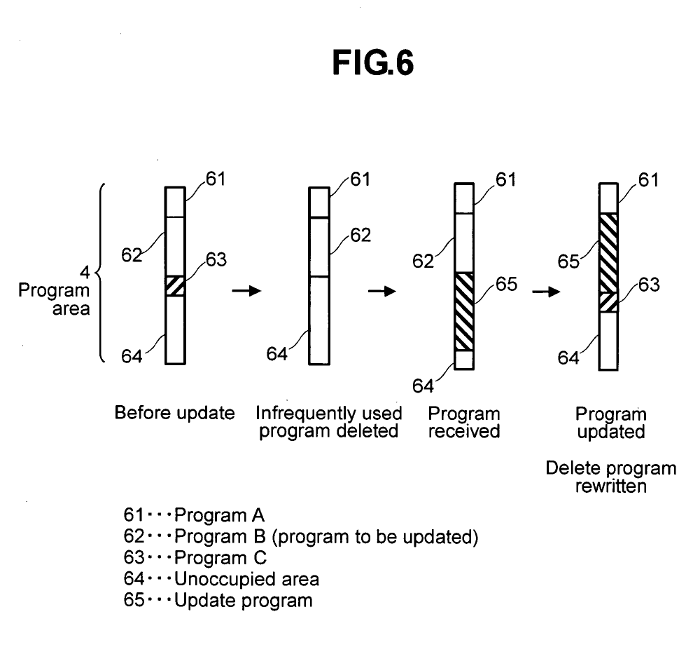

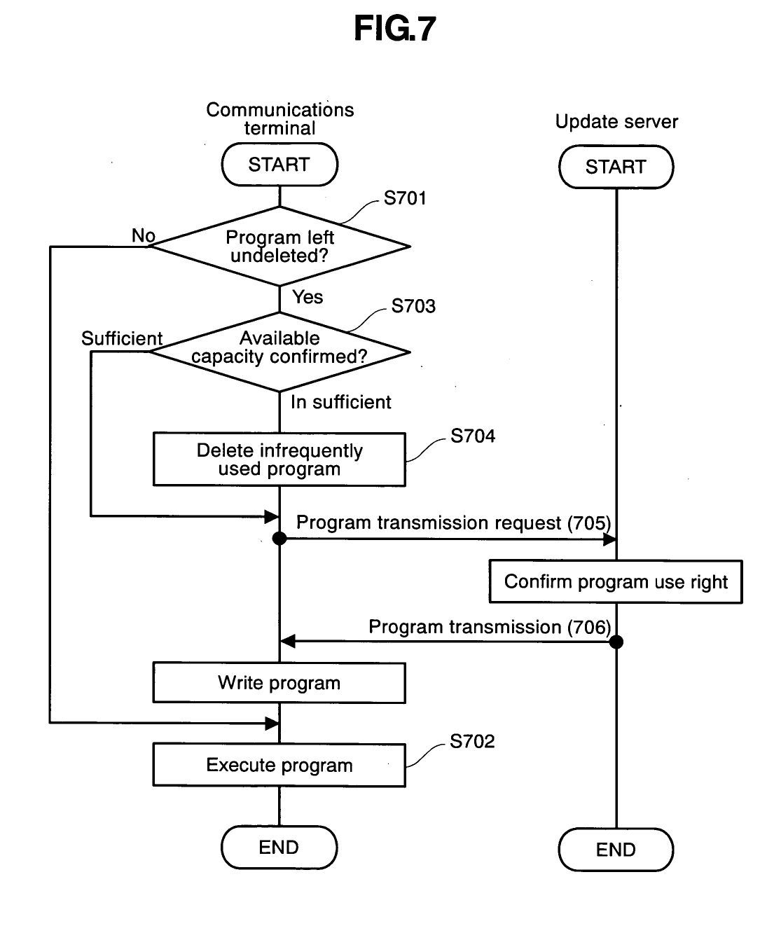

The process for receiving an update program by deleting an infrequently used program from the program storage section 104 in a situation where the communications terminal 1 does not have an adequate storage capacity will now be described with reference to FIGS. 5, 6, and 7. FIG. 5 illustrates the procedure for performing a program update for the communications terminal 1. This procedure is obtained by modifying the program update processing sequence (step S217) shown in FIG. 2. FIG. 6 illustrates how the contents of the program storage section 104 change when the sequence indicated in FIG. 5 is followed. FIG. 7 illustrates the procedure for executing a program that is deleted in the sequence indicated in FIG. 5.

As shown in FIG. 5, an unoccupied storage area is generated by deleting an infrequently used program from the program storage section 104, and the generated unoccupied storage area is used to receive an update program. After completion of update program reception, the update process is performed.

FIG. 6 shows a program A (61); a program B (62); a program C (63); an unoccupied area 64; and an update program 65. It is assumed that program B is to be updated, that program B is infrequently used, and further that the size of the update program is larger than that of the unoccupied area 64. In this instance, it is preferred that program C, which is infrequently used, be deleted to increase the size of the unoccupied area 64 for the purpose of receiving the update program. When such a process is performed in a situation where the temporary storage section 108 is not incorporated, it is possible to use the program storage section 104 as a temporary storage and perform a program update even if the program storage section 104 does not have an adequate free space.

(1) First of all, the communications terminal 1 transmits a program size notification request to the update server 3 (step S501). The program size notification request requests information concerning the update program size. It is used to check whether the communications terminal 1 has an adequate free space for receiving the update program.

(2) Upon receipt of the program size notification request, the update server 3 transmits the update program size to the communications terminal 1 (step S502). The program size notification informs the communications terminal 1 of the update program size.

(3) Upon receipt of the program size notification, the communications terminal 1 checks the size of a free space in the program storage section 104 (step S503). More specifically, the communications terminal 1 checks whether the size of the unoccupied area 64 is larger than the size of the update program. If a sufficient free space is available (step S503=Sufficient), the communications terminal 1 proceeds to step 3505 and begins to receive the program. If, on the other hand, the available free space is insufficient (step 5503=Insufficient), the communications terminal 1 proceeds to step S504.

(4) When it is concluded that the available free space is insufficient, the communications terminal 1 references the usage storage section 106 and deletes an infrequently used program from the program storage section 104 (step S504). When this process is performed, the size of the unoccupied area 64 in the program storage section 104 can be rendered larger than the update program size, which is indicated by the program size notification transmitted in step S502, in order to receive the update program 53.

(5) When the infrequently used program is deleted so that the update program 65 can be stored, the communications terminal 1 transmits a program transmission request to the update server (step S505).

(6) Upon receipt of the program transmission request, the update server 3 begins to transmit the update program that is designated by the program transmission request (step S506). The communications terminal 1 begins to receive the update program, which is transmitted from the update server 3, and then stores the received update program in the program storage section 104.

(7) While the update program is being received, the communications terminal 1 checks whether the entire program reception process has been completed (step S507). If the entire program reception process has not been completed (step S507=ln progress), the program reception process continues. If the communications link is disconnected during program reception (step S507=Aborted), the process terminates. If, on the other hand, the entire program reception process has been completed (step S507=Completed), the communications terminal 1 concludes that the program reception process has ended, and then proceeds to step S508.

(8) When it is concluded that the entire program reception process has been completed, the communications terminal 1 uses the update program 65 stored in the program storage section 104 to update the program 65 that is stored in the program storage section 104 and is targeted for an update (step S508). More specifically, the program stored in the program storage section 104 is updated (rewritten) to create a new program. When this process is performed, the program update is complete.

(9) When the program update is complete, the communications terminal 1 erases the update program 65 from the program storage section 104 (step S509), and it transmits a program update completion notification to the update server 3 (step S510).

(10) After the program update completion notification is transmitted, the communications terminal 1 checks for a program that has been deleted from the program storage section 104 (step S511). If no program has been deleted from the program storage section 104 (step S511=No), the process terminates. If, on the other hand, some program has been deleted from the program storage section 104 (step S511=Yes), the communications terminal 1 transmits a program transmission request to the update server 3 (step S512).

(11) Upon receipt of the program transmission request, the update server 3 reads the program that was deleted from the update program storage section 301 by the user, and then transmits it to the communications terminal 1 (step S513). The communications terminal 1 stores the received program in the program storage section 104 and terminates the process.

As described above, even when the storage capacity of the communications terminal is limited, an infrequently used program can be temporarily deleted from the program storage section 104 to make an unoccupied area available for use in the program storage section 104 as a temporary storage. Therefore, the program targeted for an update can be updated without adding a new work area. Although the foregoing description relates to a program update, the present invention can also be applied to a situation where a new program is added instead of updating an existing one.

Even when the communications terminal has a limited storage capacity, as described above, the present embodiment can delete a program from the program storage section to use the program storage section as a temporary storage. In this manner, the present invention can rewrite the program targeted for an update without adding a new work area while keeping the program available even when the process is interrupted due, for instance, to communications link disconnection or user intervention.

In the foregoing description, the present embodiment assumes that the program is received immediately after it is deleted from the update server (steps S512 and S513). Alternatively, however, the program may be received when the user is about to perform an update instead of being received immediately after its deletion. This case will now be described with reference to FIG. 7.

First of all, when an attempt is made to execute a program, the program storage section 104 is checked to determine whether the program to be executed is present in storage (step S701). If the program is found in the program storage section 104 (step S701=Yes), the program is executed on the spot (step S702). However, if the program is not found (step S701=No), the size of a free space in the program storage section 104 is determined (step S703). If the available free space is not adequate for storing the program to be executed (step S703=Insufficient), the usage storage section 106 is referenced to delete the most infrequently used program (step S704) with a view toward increasing the size of the free space in the program storage section 104. If, on the other hand, the available free space is adequate for storing the program to be executed, the next process begins without deleting the most infrequently used program (step S704). The communications terminal 1 transmits a program transmission request for the program to be executed to the update server 3 (step S705). Upon receipt of the program transmission request, the update server 3 transmits the program to the communications terminal 1 (step S706). Upon receipt of the program, the communications terminal 1 writes the received program into the program storage section 104 and executes it (step S702).

Although the method for a program update has been described, it can also be used for updating data such as storage/distribution data. The method for a data update will be described below.

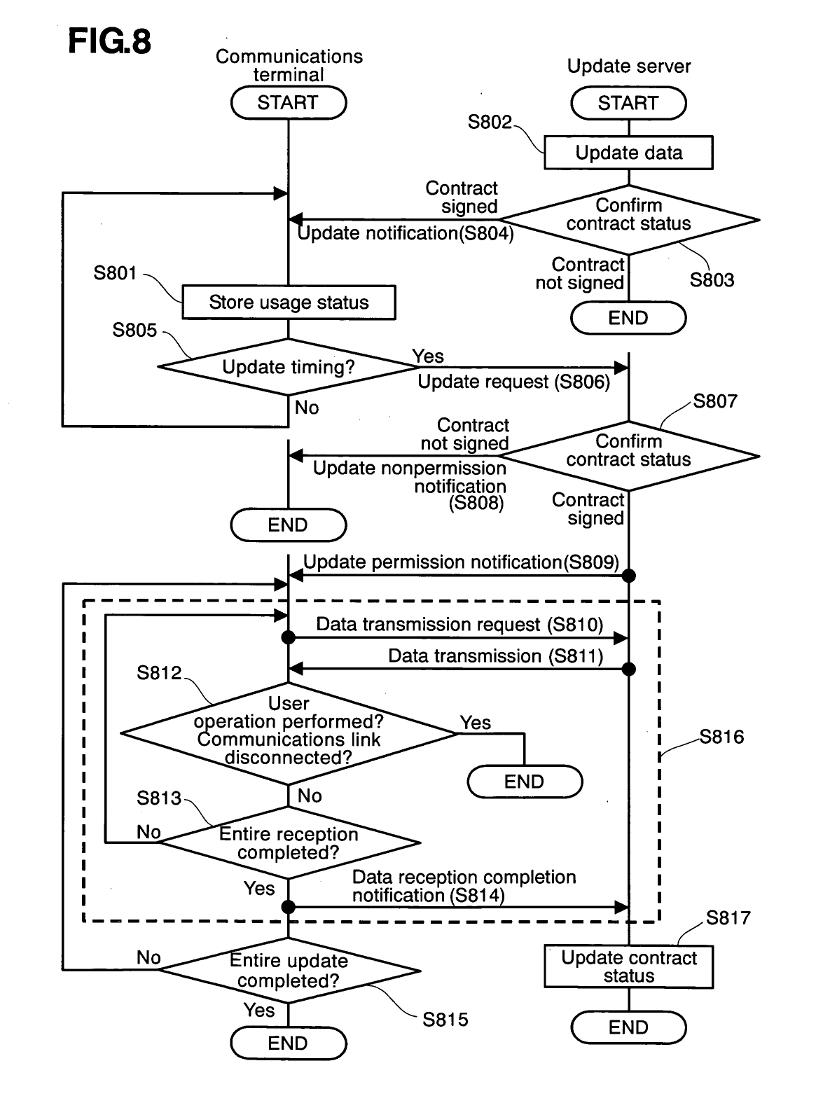

The process for receiving data via a communications link and updating the data in the communications terminal will now be described with reference to FIG. 8.

FIG. 8 illustrates the procedure for a data update that is performed by the communications terminal 1. This figure is similar to FIG. 2. More specifically, FIG. 8 shows how the communications terminal 1 stores the usage status and performs a data update with appropriate timing. Although the data update steps will be described below, the steps identical with those in FIG. 2 will not be described in detail again.

(1) The communications terminal 1 stores various information, including the date/time, day of the week, and time slot information about the user's use of the communications terminal 1, the frequency and time of the use of various programs, and the frequency and time of the use of various data, into the usage storage section 106 (step S801). The contents of the usage status to be stored are the same as those indicated in FIG. 2.

(2) When new data or the update data for previously created data is created, the update server 3 stores it in the update data storage section 301 (step S802).

(3) The update server 3 references the user contract storage section 305 to determine whether the user's contract allows the user to use the newly created data or update data. If the user's contract does not allow the user to use the data (step S803=Contract not signed), the process terminates. If, on the other hand, the user's contract allows the user to use the data (step S803=Contract signed), the process proceeds to step S804.

(4) If it is found that the user's contract allows the user to use the data, the communication section 303 transmits an update notification to the user's communications terminal 1 (step S804).

(5) Upon receipt of the update notification, the control section 102 of the communications terminal 1 references the usage storage section 106 to confirm the update timing and determine the time at which a data update can be performed (step S805). If it is concluded that the data update cannot be performed, or if the update notification is not received in step S804 (step S805=No), the control section 102 continuously performs step S801 to record the information about usage status.

If any urgent data is to be updated (if, for instance, the storage/distribution data relates to an earthquake, tidal wave, typhoon, flood, fire, war, terrorism, or other critical incident), priority may be given to the data update so as to issue an update request after answering “No” to query step S805 (step S806). This ensures that urgent data can be promptly updated to convey important information to the user without delay.

(6) Upon receipt of the update request, the control section 304 of the update server 3 references the user contract storage section 305 to confirm the contract for the communications terminal 1 (step S807). If the user's contract does not permit the use of the data (step S807=Contract not signed), the control section 304 transmits an update nonpermission notification to the communications terminal 1 and the process ends (step S808). If, on the other hand, one or more signed contracts permit the use of the data (step S807=Contract signed), the control section 304 transmits an update permission notification for only the contracted data to the communications terminal 1 (step S809).

(7) Upon receipt of the update permission notification, the communications terminal 1 transmits a data transmission request for data designated by the update permission notification to the update server 3 (step S810). If a plurality of pieces of data are designated by the update permission notification, the communications terminal 1 transmits a data transmission request for one of such data items. Data transmission requests for a plurality of programs will not be simultaneously transmitted. Steps S810 through S814 are performed for each data item to transmit a data transmission request for each data item.

(8) Upon receipt of the data transmission request, the update server 3 begins to transmit update data designated by the data transmission request (step S811). The communications terminal 1 begins to receive the update data, which is transmitted from the update server 3, and stores the received update data in the temporary storage section 108. The communications terminal 1 may alternatively store the received update data directly into user data storage section 105.

(9) When the program reception process starts, the communications terminal 1 monitors the communication status to check whether the communications link is disconnected (step S812). If the communications link is disconnected due, for instance, to a user operation performed during data reception or a communication link failure (step S812=Yes), the process aborts. If, on the other hand, the communications link is not disconnected (step S812=No), the data reception process continues and proceeds to step S813.

(10) While data is being received with the communications link left connected, the communications terminal 1 checks whether the entire data reception process has been completed (step S813). If the entire data reception process has not been completed (step S813=No), the data reception process continues. If, on the other hand, the entire data reception process has been completed (step S813=Yes), the communications terminal 1 concludes that the data reception process is ended, and then proceeds to step S814.

(11) When the entire data reception process is complete, the communications terminal 1 transmits an update completion notification about the data to the update server 3 (step S814).

(12) After the update completion notification is transmitted, the communications terminal 1 checks whether the data targeted for an update is entirely received (step 3815). If a plurality of pieces of data are designated by the update permission notification in step S809, processing steps S810 through S814 are performed for each data item. Therefore, the communications terminal 1 checks whether any data remains to be updated. If all the data designated by the update permission notification are not received (step S815=No), the data update processing sequence, which involves steps S810 through S814, is repeated for each data item (step S816). The process terminates when all the data designated by the update permission notification are completely updated (step S816=Yes).

As described above, an update is performed while considering the user's use of the communications terminal 1. It is therefore possible to perform an update during a time slot during which the user does not use the communications terminal 1, and provide increased user-friendliness by avoiding a situation where the user cannot use the communications terminal. For regular storage/distribution or the like, no provision is made to ensure that update data is received depending on a time slot during which the user uses the communications terminal. It is therefore possible to avoid a problem in which the communications terminals is rendered unavailable because update data reception begins while the user is using the communications terminal. Further, the frequency of the user's data use can be considered to avoid updating data that need not be updated. This makes it possible to reduce the cost of communication and the amount of communication data. Since the amount of communication data can be reduced, it is possible to shorten the period of time during which another communications terminal or server cannot access the local communications terminal 1 and reduce the communication traffic. It is also possible to rewrite only the data targeted for an update in accordance with the contents of the contract, thereby reducing the cost of communication, the amount of communication data, and the volume of communication traffic.

Further, the above description deals with a case where the reception process is performed for each data. Alternatively, however, a plurality of pieces of data may be simultaneously received. More specifically, the communications terminal 1 may transmit a data transmission request for a plurality of pieces of data if the remaining capacity is adequate for receiving the plurality of pieces of data, and cause the update server 3 to simultaneously transmit the plurality of pieces of data.

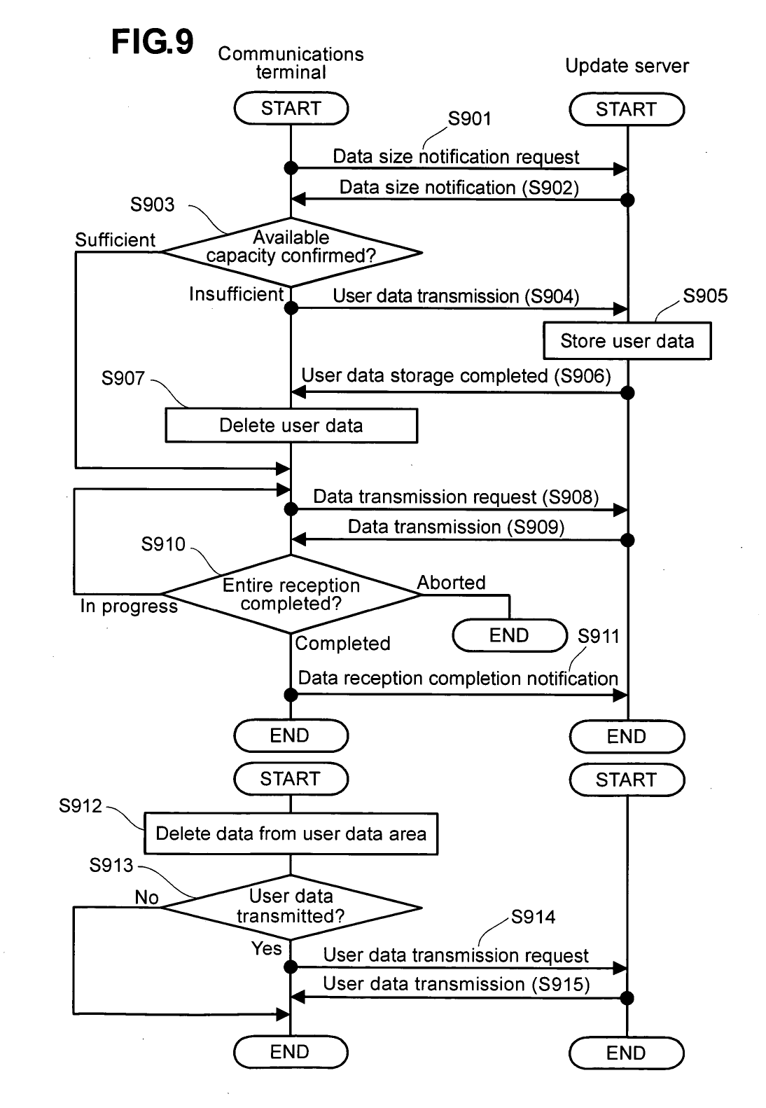

The process for receiving update data in a situation where the communications terminal 1 does not have an adequate storage capacity will be described below with reference to FIG. 9. FIG. 9 illustrates a data update procedure for the communications terminal 1. It is obtained by modifying the data update processing sequence (step S816) shown in FIG. 8. FIG. 9 is similar to FIG. 3.

As shown in FIG. 9, the data in the user data storage section 105 within the communications terminal 1 is transmitted to the update server 3 to delete the data from the user data storage section 105. The resulting free space is then used to receive update data. After completion of update data reception, an update process is performed. When these processing steps are performed, the user data storage section 105 can be used as a temporary storage in a situation where the temporary storage section 108 is not incorporated. Further, a data update can be performed even when the user data storage section 105 does not have an adequate free space. Although the processing steps will be described below, the steps identical with those in FIG. 3 will not be described in detail again.

(1) First of all, the communications terminal 1 transmits a data size notification request to the update server 3 (step S901). The data size notification request requests information concerning the update data size. It is used to check whether the communications terminal 1 has an adequate free space for receiving the update data.
(2) Upon receipt of the data size notification request, the update server 3 transmits the update data size to the communications terminal 1 (step S902). The data size notification informs the communications terminal 1 of the update data size.

(3) Upon receipt of the data size notification, the communications terminal 1 checks the size of a free space in the user data storage section 105 (step S903). If a sufficient free space is available (step S903=Sufficient), the communications terminal 1 proceeds to step S908 and begins to receive the data. If, on the other hand, the available free space is insufficient (step S903=Insufficient), the communications terminal 1 proceeds to step S904.

(4) When it is concluded that the available free space is insufficient, the communications terminal 1 transmits the user data stored in the user data storage section 105 to the update server 3 (step S904).

(5) When the user data is transmitted from the communications terminal 1, the update server 3 saves the transmitted user data in the user data storage section 302 (step S905). In this instance, the data is saved in such a manner that the user of the transmitted data can be identified. For example, a folder is created for each user and is used to store the associated user data.

(6) After the user data is saved, the update server 3 transmits a user data storage completion notification to the communications terminal 1 (step S906).

(7) Upon receipt of the user data storage completion notification, the communications terminal 1 deletes the user data from the user data storage section 105 (step S907).

(8) When the update data can be stored due to user data deletion, the communications terminal 1 transmits a data transmission request to the update server 3 (step S908).

(9) Upon receipt of the data transmission request, the update server 3 begins to transmit data that is designated by the data transmission request (step S909). The communications terminal 1 begins to receive the update data, which is transmitted from the update server 3, and then stores the received update data in the user data storage section 105.

(10) While the update data is being received, the communications terminal 1 checks whether the entire data reception process has been completed (step S910). If the entire data reception process has not been completed (step S910=ln progress), the data reception process continues. If the communications link is disconnected during data reception (step S910=Aborted), the process terminates. If, on the other hand, the entire data reception process has been completed (step S910=Completed), the communications terminal 1 concludes that the data reception process is ended, and then proceeds to step S911.

(11) When the data has been entirely received, the communications terminal 1 transmits a data update completion notification to the update server 3 (step S911) and then terminates the process.

In marked contrast to program reception, it may sometimes be improper in data reception to return the user data saved in the update server 3 to the communications terminal 1 immediately after update data reception. In the case of program reception, an unoccupied area can be immediately obtained by deleting an unupdated, unnecessary program. In the case of data reception, however, the user may wish to retain the unupdated data. In such an instance, an unoccupied area may not be obtained because unupdated data cannot always be deleted.

It is conceivable that the user data saved in the update server 3 may be returned to the communications terminal 1, for instance, when the user performs a procedure for deleting the user data of the communications terminal 1 to generate an unoccupied area, when the user chooses to delete the user data in response to a deletion prompt issued by the communications terminal 1, or when new data is distributed. When the above-described operation is performed, the process shown in FIG. 9 resumes. Details are given below.

(12) The communications terminal 1 deletes the data from the user data storage section 105 (step S912).

(13) After the data is deleted, the communications terminal 1 judges whether the user data is transmitted to the update server 3 (step S913). If the user data is not transmitted (step S913=No), the process terminates. If, on the other hand, the user data is transmitted to the update server 3 (step S913=Yes), the communications terminal 1 transmits a user data transmission request to the update server 3 (step S914).

(14) Upon receipt of the user data transmission request, the update server 3 transmits the user data saved in the user data storage section 302 to the communications terminal 1 (step S915). The communications terminal 1 stores the received user data in the user data storage section 105 and terminates the process.

As described above, a communications terminal having a limited storage capacity can update data targeted for an update by saving the data in the user data storage section in the update server 3.

The foregoing description, which is given with reference to FIG. 9, has not covered a situation where the data reception process (steps S908 and S909) is aborted due, for instance, to a user intervention or communications link failure (step S910=Aborted) so that the process ends with the user data being erased from the communications terminal 1. However, the user data can be acquired by transmitting an acquisition request again to the update server 3. Further, the foregoing description has dealt with a case where the update server 3 unlimitedly saves the user data. However, the update server 3 may alternatively save the user data only when the signed contract states that the storage of user data or an increase or decrease in the storage capacity is in accordance with the contract. If there is no contract for user data storage, the update server 3 may alternatively terminate the data update process because it cannot receive the update data. Although the description given with reference to FIG. 9 has dealt with a case where the user data is transmitted, part of a program or data other than the user data may alternatively be transmitted.

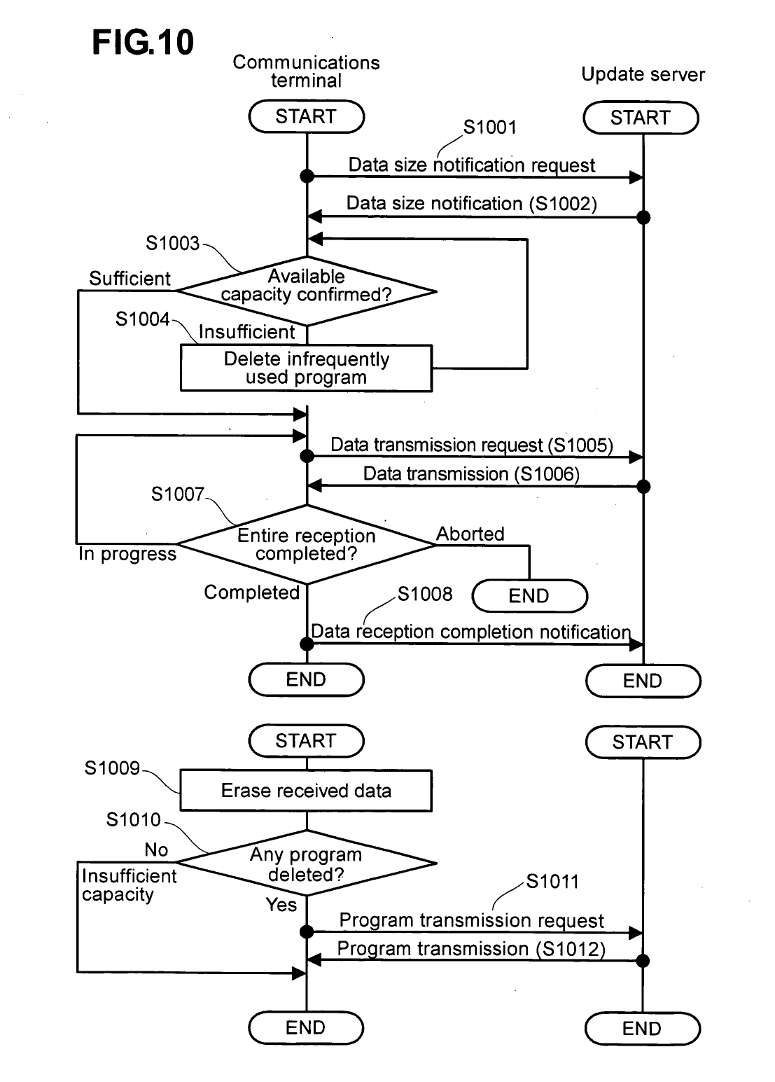

The process for receiving update data by deleting infrequently used data from the user data storage section 105 in a situation where the communications terminal 1 does not have an adequate storage capacity will now be described with reference to FIG. 10. FIG. 10 illustrates the data update procedure for the communications terminal 1. It is obtained by modifying the data update processing sequence (step S816) shown in FIG. 8. FIG. 10 is similar to FIG. 5.

As indicated in FIG. 10, infrequently used data is deleted from the user data storage section 105 to generate an unoccupied area. The generated unoccupied area is then used to receive update data and perform an update process. When this process is performed, a data update can be performed even if the user data storage section 105 does not have an adequate free space. Although the processing steps will be described below, the steps identical with those in FIG. 5 will not be described in detail again.

(1) First of all, the communications terminal 1 transmits a data size notification request to the update server 3 (step S1001). The data size notification request requests information concerning the update data size. It is used to check whether the communications terminal 1 has an adequate free space for receiving the update data.

(2) Upon receipt of the data size notification request, the update server 3 transmits the update data size to the communications terminal 1 (step S1002). The data size notification informs the communications terminal 1 of the update data size.

(3) Upon receipt of the data size notification, the communications terminal 1 checks the size of a free space in the user data storage section 105 (step S1003). If a sufficient free space is available (step S1003=Sufficient), the communications terminal 1 proceeds to step S1005 and begins to receive the data. If, on the other hand, the available free space is insufficient (step S1003=Insufficient), the communications terminal 1 proceeds to step S1004.

(4) When it is concluded that the available free space is insufficient, the communications terminal 1 references the usage storage section 106 and deletes an infrequently used program from the program storage section 104 to obtain a free space for update data storage (step S1004).

(5) When the infrequently used program is deleted to permit update data storage, the communications terminal 1 transmits a data transmission request to the update server 3 (step S1005).

(6) Upon receipt of the data transmission request, the update server 3 begins to transmit data that is designated by the data transmission request (step S1006). The communications terminal 1 begins to receive the update data, which is transmitted from the update server 3, and then it stores the received update data in the user data storage section 105.

(7) While the update data is being received, the communications terminal 1 checks whether the entire data reception process is complete (step S1007). If the entire data reception process has not been completed (step S1007=In progress), the data reception process continues. If the communications link is disconnected during data reception (step S1007=Aborted), the process terminates. If, on the other hand, if the entire data reception process is complete (step S1007=Completed), the communications terminal 1 concludes that the data reception process is ended, and then proceeds to step S1008.

(8) When the data has been entirely received, the communications terminal 1 transmits a data reception completion notification to the update server 3 (step S1008) and then terminates the process.

It is conceivable that the program deleted from the update server 3 may be returned to the communications terminal 1, for instance, when the user performs a procedure for starting the program, when the user performs a procedure for deleting the user data of the communications terminal to generate an unoccupied area, when the user chooses to delete the user data in response to a deletion prompt issued by the communications terminal 1, or when new data is distributed. When the above-described operation is performed, the process shown in FIG. 10 resumes. Details are given below.

(12) The communications terminal 1 deletes the data from the user data storage section 105 (step S1009).

(13) After the data is deleted, the communications terminal 1 judges whether any program is deleted in step S1004 (step S1010). If no program is deleted (step S1010=No), the process terminates. If, on the other hand, a certain program is deleted (step S1010=Yes), the communications terminal 1 transmits a program transmission request to the update server 3 (step S1011).

(14) Upon receipt of the user data transmission request, the update server 3 transmits the deleted program to the communications terminal 1 (step S1012). The communications terminal 1 stores the received program in the program storage section 104 and then terminates the process.

As described above, a communications terminal having a limited storage capacity can perform a data update by deleting a program from the program storage section and using the program storage section as a user data storage section.

The program update and data update methods for the communications terminal in accordance with the present invention have been described above.

In the foregoing description, which is given with reference to FIGS. 1 through 10, the program storage section 104 is distinguished from the user data storage section 105. Alternatively, however, a single storage section may be used to perform the functions of the program storage section and user data storage section. For example, programs and user data may be stored in contiguous areas with the same storage section. This results, for instance, in storage section downsizing and cost reduction.

The present invention provides a user-friendly communications terminal.

1. A communications terminal comprising:
a communication section for establishing communication;
a storage section for storing a program;
a control section for controlling said communication section and said storage section; and
a usage storage section for storing the usage status;
wherein the program stored in said storage section is updated using usage status stored in said usage storage section.

2. The communications terminal according to claim 1, wherein said usage storage section stores the date/time, day of the week, or time slot during which the communications terminal is used, and wherein said program is updated at a time other than stored said date/time, day of the week, or time slot.

3. The communications terminal according to claim 1, wherein said usage storage section stores the time or frequency of use of the program stored in said storage section, and wherein the programs are updated only when said time or frequency of use is above a predefined level.

4. A communications terminal comprising:
a communication section for establishing communication;
a storage section for storing data;
a control section for controlling said communication section and said storage section; and
a usage storage section for storing the usage status;
wherein the usage status stored in said usage storage section is used to update the data stored in said storage section.

5. The communications terminal according to claim 4, wherein said usage storage section stores the date/time, day of the week, or time slot during which the communications terminal is used, and wherein said stored data is updated at a time other than stored said date/time, day of the week, or time slot.

6. The communications terminal according to claim 4, wherein said usage storage section stores the time or frequency of use of the data stored in said storage section, and wherein the data is updated only when said time or frequency of use is above a predefined level.

7. A communications terminal comprising:
a communication section for establishing communication;
a storage section for storing a program and data; and
a control section for controlling said communication section and said storage section;
wherein, if said storage section does not have a free space for updating said program or data, said communication section transmits part of the program or data stored in said storage section to a server; and
wherein said storage section deletes said transmitted part of the program or data and updates said program or data.

8. A communications terminal comprising:
a communication section for establishing communication;
a storage section for storing a program and data; and
a control section for controlling said communication section and said storage section;
wherein said program or data is updated only when the user is privileged to use said program or data.

9. A communication system comprising:
a communications terminal which includes a communication section for establishing communication, a storage section for storing a program and data, and a control section for controlling said communication section and said storage section; and
a server which includes a communication section for communicating with said communications terminal via a communication network, a storage section for storing an update program and data, and a control section for controlling said communication section and said storage section;
wherein said communications terminal includes a usage storage section for storing the usage status of the communications terminal, and transmits an update request for the program or data stored in the storage section to said server in accordance with the usage status stored in the usage storage section; and
wherein, upon receipt of said update request for the program or data from said communications terminal, said server transmits the update program or update data to said communications terminal.

10. A method for updating a communications terminal program, comprising the steps of:
storing the usage status of a communications terminal; and
updating a program in accordance with said usage status stored.

11. A method for updating communications terminal data, comprising the steps of:
storing the usage status of a communications terminal; and
updating data in accordance with said usage status stored.

12. An information processing device for performing a first information process and a second information process, comprising:
a usage storage section for storing execution information about said first information process,
wherein the execution information about said first information process, which is stored in said usage storage section, is used to perform a second information process.
